(19) United States
(12) Patent Application Publication
(10) Pub. No.: US 2011/0017026 A1
(43) Pub. Date: Jan. 27, 2011

(54) Identification Structure for a Socket

(76) Inventor: Chuck CHANG, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/780,829

(22) Filed: May 14, 2010

(30) Foreign Application Priority Data
Jul. 23, 2009 (TW) 098213502

(51) Int. Cl. B25B 13/06

(52) U.S. Cl. 81/124.6

(57) ABSTRACT

An identification structure formed on an outer surface of the socket comprises two parts for indentifying the sizes of the working hole and the square hole, respectively. The part for identifying the size of the square hole includes at least one identification area consisting of at least one axial identification portion or one radial identification portion or a combination of the at least one axial identification portion and the radial identification portion. Each of the axial and radial identification portions is a rectangular structure. The axial identification portion each represents a ⅛ inch, and the radial identification portion each represents 1 inch.

### BACKGROUND OF THE INVENTION

1. Field of the Invention

The present invention relates to an identification structure, and more particularly to an identification structure for a socket.

2. Description of the Prior Art

Referring to FIG. 1, a socket is normally provided with a polygonal working hole 11 and a connecting end 12 in the form of a square hole. The working hole 11 is used to fit a corresponding sized work piece 91, and the connecting end 12 is used for insertion of the square head 920 of a driving tool 92. For easy identification of the size of the work piece 91 suitable for being driven by the socket 10, the outer surface of the socket 10 is formed with an identification structure 13 which is marked with the size of the work piece 91 to be driven by the socket 10. However, the size of the square head 920 of the driving tool 92 which is suitable for connecting and driving the connecting end 12 of the socket 10 is not shown, causing inconvenience to the user.

The present invention has arisen to mitigate and/or obviate the afore-described disadvantages.

### SUMMARY OF THE INVENTION

The primary object of the present invention is to provide an identification structure for a socket which allows easy and quick identification of the size of the square hole of the socket.

To achieve the above object, an identification structure formed on an outer surface of the socket comprises an identification part for indentifying a size of the working hole and another identification part for identifying a size of the square hole, the identification part for identifying the size of the square hole includes at least one identification area consisting of at least one axial identification portion or one radial identification portion or a combination of the at least one axial identification portion and the radial identification portion.

Each of the axial and radial identification portions is a rectangular structure with two long sides and two short sides, the long sides of the axial identification portion extend in an axial direction of the socket, while the long sides of the radial identification portion extend in a direction vertical to the axial direction of the socket.

When there are plural radial and axial identification portions, the radial identification portions are parallel to one another, and so are the axial identification portions. Each of the radial and axial identification portions represents a size, so that the size of the square hole of the socket is easily identifiable.

### BRIEF DESCRIPTION OF THE DRAWINGS

FIG. 1 shows a conventional socket with an identification structure;

FIG. 2 is a perspective view of an identification structure for a socket in accordance with the present invention;

FIG. 3 is an illustrative view of the present invention showing that the identification portions are protruded out of the outer surface of the socket;

FIG. 4 is an illustrative view of the present invention showing that the identification portions are recessed into the outer surface of the socket;

FIG. 5 is an illustrative view of an identification structure for a socket in accordance with the present invention showing that the size indicated by the identification structure is 0.25 inch;

FIG. 6 is an illustrative view of an identification structure for a socket in accordance with the present invention showing that the size indicated by the identification structure is 0.5 inch;

FIG. 7 is an illustrative view of an identification structure for a socket in accordance with the present invention showing that the size indicated by the identification structure is 1 inch; and

FIG. 8 is an illustrative view of an identification structure for a socket in accordance with the present invention showing that the size indicated by the identification structure is 1.5 inch.

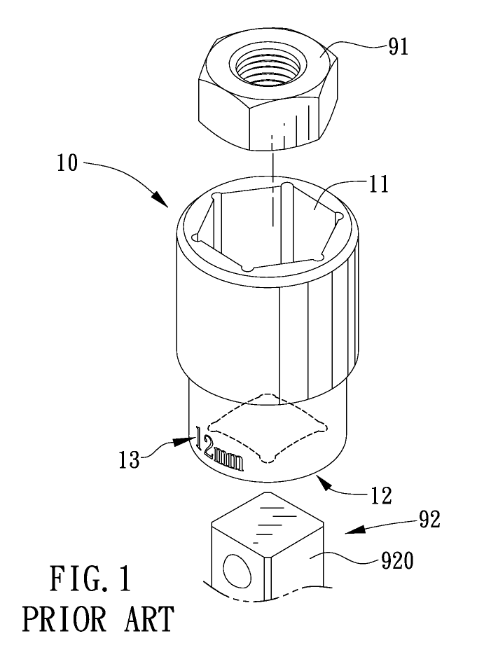

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

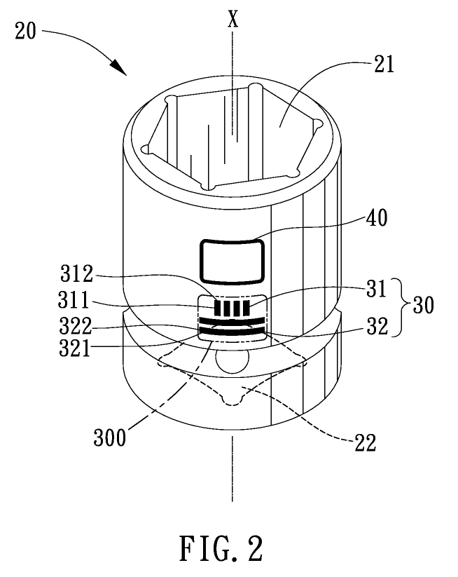

Referring to FIGS. 2-6, an identification structure for a socket 20 in accordance with the present invention is formed on an outer surface of the socket 20. The socket 20 is provided with a polygonal working hole 21 at one end thereof and in an axial direction X thereof for engaging with and driving a workpiece of corresponding shape and size. Another end of the socket 20 is axially formed with a square hole 22 for engaging with the square head of a driving tool, such as wrench, so that the workpiece in the working hole 21 of the socket 20 can be efficiently driven by the driving tool.

The identification structure consists of part 40 and part 30 for indicating the sizes of the working hole 21 and the square hole 22, respectively. The part 40 of the identification structure is the same as the conventional identification structure as mentioned above and no further remarks are necessary. The part 30 of the identification structure includes an identification area 300 consisting of at least one axial identification portion 31 or one radial identification portion 32 or the combination of the two. The axial identification portion 31 is a rectangular structure with two long sides 311 and two short sides 312. The long sides 311 extend in the axial direction X of the socket 20. When there are plural axial identification portions 31, the axial identification portions 31 are parallel to one another. One axial identification portion 31 represents a ⅛ inch. The radial identification portion 32 is a rectangular structure with two long sides 321 and two short sides 322. The long sides 321 extend in a direction vertical to the axial direction X of the socket 20. When there are plural radial identification portions 32, the radial identification portions 32 are parallel to one another. One radial identification portion 32 represents one inch. As shown in FIG. 2, there are four axial identification portions 31 and two radial identification portions 32 on the socket 20, which means that the size of the square hole 22 is: 4×⅛ inch+2 inches=2.5 inches, and in other words, the socket 20 is suitable for use with a driving tool with a 2.5 inch square head.

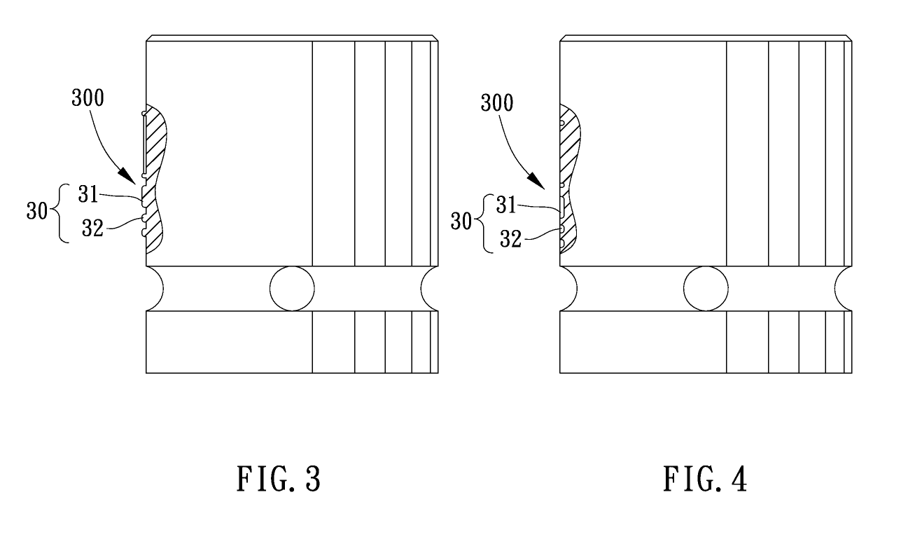

The identification portions 31, 32 can be protruded out of or recessed into the outer surface of the socket 20, as shown in FIGS. 3 and 4, which allows haptic perception.

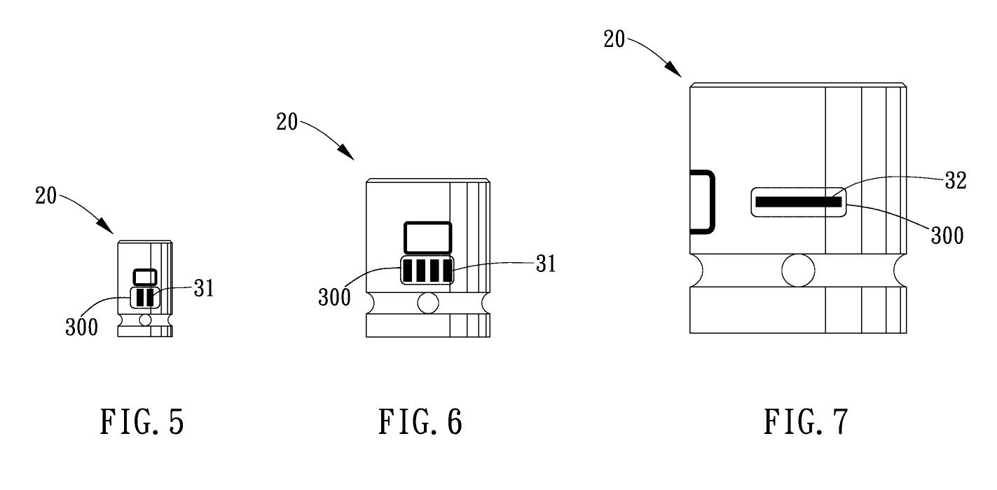

Referring to FIGS. 5 and 6, the part 30 of the identification structure of the socket 20 consists purely of axial identification portions 31. As shown in FIG. 5, there are two axial identification portions 31, which means that the size of the square hole 22 of the socket 20 is: 2×⅛=0.25 inch. There are four axial identification portions 31 on the socket 20 as shown in FIG. 6, and the size of the square hole 22 of the socket 20 is 4×⅛=0.5 inch, which means that the socket 20 is suitable for use with a driving tool with a 0.5 inch square head.

Referring to FIG. 7, the socket 20 can also comprise only a radial identification portion 32, indicating that the size of the square hole 22 of the socket 20 is 1 inch.

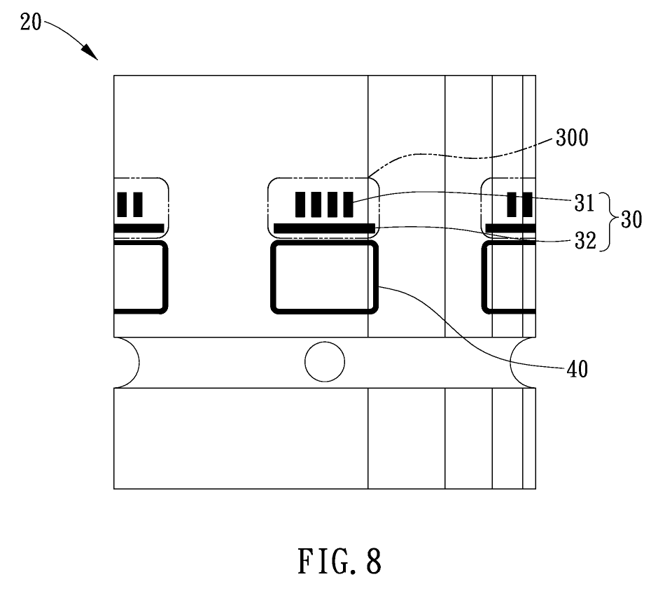

Referring to FIGS. 2-6 again, the identification area 300 is located close to the end of the socket 20 where the square hole 22 is located. Or, it can be located at the same level as the part 40 of the identification structure, as shown in FIG. 7, Or, the parts 30 and 40 of the identification structure can be exchanged in position, as shown in FIG. 8, the socket 20 is simultaneously provided with axial and radial identification portions 31, 32, namely, four axial identification portions 31 and one radial identification portion 32, which means that the size of the square hole 22 of the socket is: 4×⅛+1=1.5 inch. Furthermore, the number of identification area 300 of the socket 20 can be varied as desired, for example, there four identification areas 300 evenly distributed on the outer surface of the socket 20 shown in FIG. 8 for easy identification.

To summarize, the part 30 of the identification structure of the socket 20 in accordance with the present invention is simple and easy to understand. With the arrangements of the rectangular axial and radial identification portions, the part 30 of the identification structure also provides a decorative look for the socket 20. Furthermore, the axial and radial identification portions 31, 32 are rectangular shaped and accordingly they are easy to make.

While we have shown and described various embodiments in accordance with the present invention, it is clear to those skilled in the art that further embodiments may be made without departing from the scope of the present invention.

What is claimed is:

1. An identification structure for a socket being formed on an outer surface of the socket, the socket being axially provided with a working hole at one end thereof and a square hole at another end thereof, the identification structure comprising an identification part for indentifying a size of the working hole and another identification part for identifying a size of the square hole, the identification part for identifying the size of the square hole including at least one identification area consisting of at least one axial identification portion or one radial identification portion or a combination of the at least one axial identification portion and the radial identification portion; wherein
each of the axial and radial identification portions is a rectangular structure with two long sides and two short sides, the long sides of the axial identification portion extend in an axial direction of the socket, while the long sides of the radial identification portion extend in a direction vertical to the axial direction of the socket.

2. The identification structure for a socket as claimed in claim 1, wherein the radial and axial identification portions are protruded out of the outer surface of the socket.

3. The identification structure for a socket as claimed in claim 1, wherein the radial and axial identification portions are recessed into the outer surface of the socket.

4. The identification structure for a socket as claimed in claim 1, wherein there are plural axial identification portions, and the axial identification portions are parallel to one another.

5. The identification structure for a socket as claimed in claim 1, wherein there are plural radial identification portions, the radial identification portions are parallel to one another.

6. The identification structure for a socket as claimed in claim 1, wherein the axial identification portion each represents a ⅛ inch.

7. The identification structure for a socket as claimed in claim 1, wherein the radial identification portion each represents an inch.

8. The identification structure for a socket as claimed in claim 1, wherein the identification part for identifying the size of the square hole includes plural identification areas which are evenly distributed on the outer surface of the socket.
